(19) United States
(12) Patent Application Publication
(10) Pub. No.: US 2003/0018758 A1
(43) Pub. Date: Jan. 23, 2003

(54) Generically provisioning an appliance

(76) Inventors: Changguan Fan, Chandler, AZ (US); Brian R. Haug, Chandler, AZ (US); Meera Desikamani, Phoenix, AZ (US)

Correspondence Address: TROP PRUNER & HU, PC, 8554 KATY FREEWAY, SUITE 100, HOUSTON, TX, 77024, US

(21) Appl. No.: 09/905,626

(22) Filed: Jul. 13, 2001

(51) Int. Cl. G06F 15/177

(52) U.S. Cl. 709/221

(57) ABSTRACT

A method, system, and apparatus for provisioning a generically pre-provisioned client device such as a web appliance upon an initial connection to a server system such as an ISP. The web appliance is pre-provisioned with enough data to enable it to connect to any of a plurality of ISPs. ISP-specific data are provisioned upon initial connection, to customize the client for use in that ISP's environment.

### BACKGROUND OF THE INVENTION

### Related Applications

This invention disclosed herein may be used in conjunction with another of our inventions, which we have disclosed in co-pending application entitled “Method for Deriving a Network Name”, and/or with another of our inventions, which we have disclosed in co-pending application entitled “Authentication Protocol”.

1. Technical Field of the Invention

The present invention relates generally to loading software onto data processing systems and to network communications, and more specifically to a method for generically provisioning a client system to work with any of a plurality of specific server environments upon initial connection to one of those environments.

2. Background Art

Various networking protocols and environments are known in the art. One such environment is that known as a client-server environment. One example of a client-server environment is a plurality of client customer workstations coupled over the internet to an internet service provider (ISP) server. Another such environment is peer-to-peer networking.

In order to work in a particular environment, a device (such as a client workstation) must be properly provisioned (with software applications, operating system environment, data, tables, keys, protocols, and the like), and must be properly configured (with settings, parameters, registry entries, and the like). For ease in explanation, the terms “configure” and “provision” will be used somewhat interchangeably.

In the example of a customer who signs up for a new ISP account, the customer's workstation will typically need to be provisioned with a compatible operating system environment, communication software, security keys, and the like, and with information such as the local dialup number through which to connect to the ISP, the correct email address and POP server address that the ISP's system will be using for that customer, and perhaps the internet address or at least the fully qualified domain name of the ISP's server.

It is known in the art that some of this may be done dynamically. For example, in many environments, the client workstation does not need to be provisioned with a static internet protocol (IP) address; rather, an IP address is obtained anew at connection time, e.g. via the well-known Dynamic Host Configuration Protocol (DHCP) service.

However, much of the provisioning and configuration must presently be done manually by the user. The user must, one by one, call up various programs and tweak their settings. For example, the user must launch the email program and alter its “Properties” with the correct SMTP and POP settings. The user must also launch the web browser program and alter its “Properties” to configure the default homepage, the news group server address, the web browser proxy settings, security levels for running e.g. ActiveX controls, how to handle cookies, and so forth.

It is also known in the art to provide registration information such as a personal identification number (PIN) to prevent unauthorized access to systems such as an ISP's servers. To prevent fraud, such as attempted internet access by persons possessing a clone of an authorized workstation, the ISP may provide a substantially unique PIN to each new authorized subscriber. Typically, this is done out of band, such as via a printed letter sent to the new authorized subscriber through postal mail.

Many customers, and potential customers, lack the technical sophistication necessary to make significant manual configurations of complex software settings. Many customers may benefit from an improved provisioning mechanism which automates more of the provisioning and configuration.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 illustrates an exemplary system in which the invention may be practiced.

FIG. 2 illustrates an exemplary flowchart of one method of practicing the invention.

### DETAILED DESCRIPTION

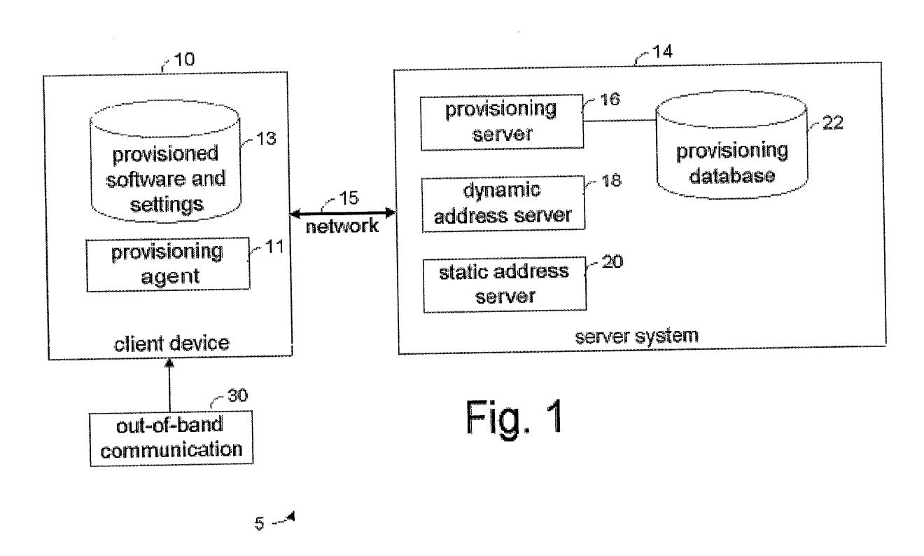

FIG. 1 shows a system 5 in which the invention may be practiced. The system includes a client device 10 coupled via network 15 to a server system 14. For purposes of illustration, the client will be discussed as being embodied as a web appliance, the network will be discussed as being embodied as the internet, and the server system will be discussed as being embodied as an ISP. However, the skilled reader will readily appreciate that the invention is not limited to these specifics.

The ISP server system 14 includes a provisioning server 16 which has access to a provisioning database 22 for provisioning the web appliance 10 when the web appliance connects to the ISP. The invention will be discussed in terms of provisioning the web appliance upon an initial connection by the web appliance to the ISP. However, the invention is not limited to such initial connection, and may be used—perhaps repeatedly—at subsequent connections, such as, for example, when the web appliance's provisioning has become stale or out of date, as in the case where a new software package or a new configuration setting have been made available in the provisioning database.

The ISP server system may further include a dynamic address server 18, such as a DHCP server, and/or a static address server 20, such as a DNS server. Alternatively, one or both of these may be embodied outside the ISP's server environment and the web appliance may access them over the internet independently from its access of the ISP.

The web appliance includes a provisioning agent 11 and a set of provisioned software and settings 13.

The web appliance may also have access to an out-of-band communication, such as data input by a user in response to a new customer authorization letter containing a PIN from the ISP.

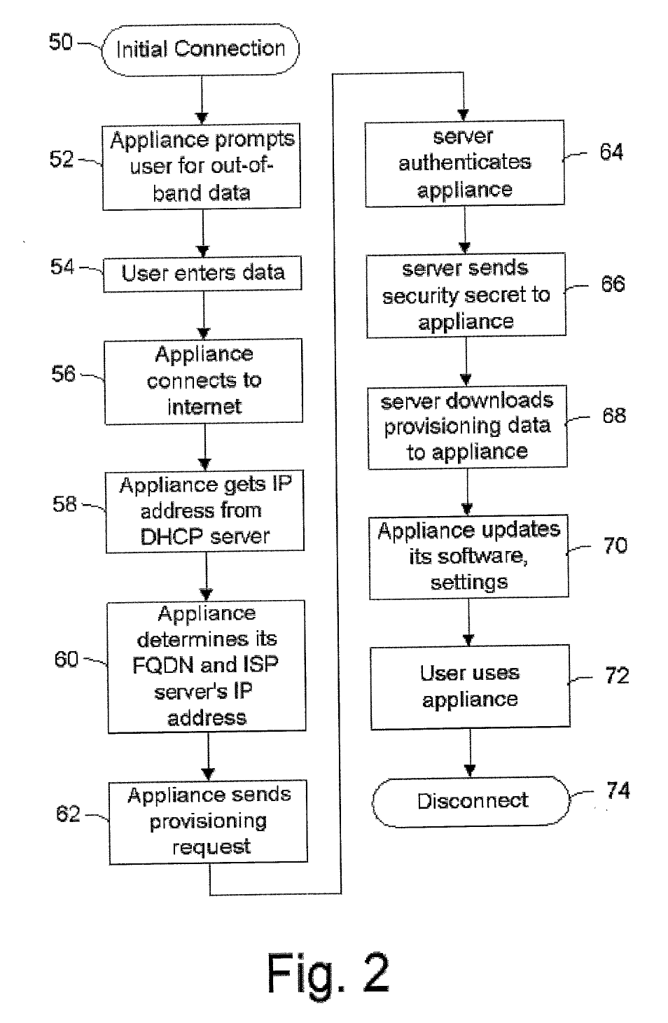

FIG. 2 shows one embodiment of a method of practicing the invention in conjunction with the exemplary system shown in FIG. 1. To begin (50) an initial connection by the web appliance to the ISP, the appliance prompts (52) the user for the out-of-band authentication data provided by the ISP, which the user enters (54). This data may include, for example, a registration number, a PIN, and/or a dialup phone number.

The appliance connects (56) to the internet and gets (58) an IP address from the DHCP server. The appliance determines (60) its fully qualified domain name (FQDN) and the ISP server's IP address, using conventional techniques or, optionally, using the techniques described in the co-pending application identified above.

The appliance may send (62) a provisioning request to the ISP server, or, in some embodiments, the request may be implicit or assumed.

The server authenticates (64) the appliance, such as by comparing data received from the appliance against a store of data concerning authorized client appliances. Such data may include information originating from the appliance itself, such as a unique processor identification number or such as a unique identifier previously stored on the appliance at manufacturing or pre-provisioning time by the ISP or its supplier. Such data may alternatively or additionally include some or all of the out-of-band data sent by the ISP to the new customer. The authentication may, in one embodiment, be done in accordance with the co-pending application identified above.

Once the appliance has (optionally) been authenticated, the server sends (66) a security secret to the appliance, such as a public key, session key, symmetric key, passcode, or the like. This secret will enable security between the server and the appliance in subsequent communications.

The server downloads (68) the provisioning data to the appliance, optionally under security provided by the previously-transmitted secret. This provisioning data may include, for example, email address, POP server, homepage URL, registry entries, software applications, news server identity, proxy server settings, and so forth. In one embodiment, the provisioning data may be sent as <parameter,value> tuples, which the provisioning agent of the web appliance knows how to interpret. The appliance receives (70) the provisioning data and updates its software, settings, parameters, and so forth, accordingly.

By provisioning such data after the customer has obtained the appliance, rather than at manufacturing time, a more flexible and user-friendly environment is provided. If, on the other hand, the full provisioning were done at manufacturing time by the manufacturer of the appliance—as is presently done in the art—the appliance would be customized for use in connecting to one specific, predetermined ISP, and perhaps even to one particular server or geographic region of that ISP's network. Thus, the appliance manufacturer would have to incur the inconvenience and expense of maintaining many separate “builds” for its various ISP customers, with the inventory issues, multiple stock keeping unit (SKU) issues, distributor issues, and so forth. Similarly, if the ISP were to fully provision the appliance before identifying the specific customer, the ISP would incur similar inventory etc. expenses. By way of contrast, this invention enables a single-SKU generic build, usable by a large variety of customers of a large variety of ISPs using a large variety of different server environments. Customer-specific and ISP-specific configuration (custom configuration) and provisioning is completed only when the generically pre-provisioned individual appliance unit is initially connected to the individual ISP server.

Once the appliance is fully configured, the user is fully able to use (72) the appliance. After the user disconnects (74), subsequent connections are more straight-forward, unless and until such time as the system re-invokes this invention to re-provision or update the appliance.

The reader should appreciate that drawings showing methods, and the written descriptions thereof, should also be understood to illustrate machine-accessible media having recorded, encoded, or otherwise embodied therein instructions, functions, routines, control codes, firmware, software, or the like, which, when accessed, read, executed, loaded into, or otherwise utilized by a machine, will cause the machine to perform the illustrated methods. Such media may include, by way of illustration only and not limitation: magnetic, optical, magneto-optical, or other storage mechanisms, fixed or removable discs, drives, tapes, semiconductor memories, organic memories, CD-ROM, CD-R, CD-RW, DVD-ROM, DVD-R, DVD-RW, Zip, floppy, cassette, reel-to-reel, or the like. They may alternatively include down-the-wire, broadcast, or other delivery mechanisms such as Internet, local area network, wide area network, wireless, cellular, cable, laser, satellite, microwave, or other suitable carrier means, over which the instructions etc. may be delivered in the form of packets, serial data, parallel data, or other suitable format. The machine may include, by way of illustration only and not limitation: microprocessor, embedded controller, PLA, PAL, FPGA, ASIC, computer, smart card, networking equipment, or any other machine, apparatus, system, or the like which is adapted to perform functionality defined by such instructions or the like. Such drawings, written descriptions, and corresponding claims may variously be understood as representing the instructions etc. taken alone, the instructions etc. as organized in their particular packet/serial/parallel/etc. form, and/or the instructions etc. together with their storage or carrier media. The reader will further appreciate that such instructions etc. may be recorded or carried in compressed, encrypted, or otherwise encoded format without departing from the scope of this patent, even if the instructions etc. must be decrypted, decompressed, compiled, interpreted, or otherwise manipulated prior to their execution or other utilization by the machine.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A method of a server system custom provisioning a generically pre-provisioned client device, the method comprising:
receiving a connection from the client device; and
downloading provisioning data to the generically pre-provisioned client device.

2. The method of claim 1 further comprising:
authenticating the generically pre-provisioned client device; and
the downloading being conditioned upon the authenticating.

3. The method of claim 2 further comprising:
sending out-of-band data to a user of the generically pre-provisioned client device prior to receiving the connection.

4. A system comprising:
a network;
a server system coupled to the network and including,
a provisioning server,
a provisioning database having stored therein provisioning data for at least one generically pre-provisioned client device; and
a generically pre-provisioned client device coupled to the server system via the network.

5. The system of claim 4 wherein the generically pre-provisioned client device comprises:
generically pre-provisioned data which have been provisioned prior to an initial connection of the generically pre-provisioned client device to the server system via the network;
out-of-band data which have been stored into the generically pre-provisioned client device by a user; and
provisioning data which have been provisioned by the provisioning server after an initial connection of the generically pre-provisioned client device to the server system via the network.

6. An article of manufacture comprising:
a machine-accessible medium including instructions that, when executed by a machine, cause the machine to perform the method of claim 1.

7. The article of manufacture of claim 6 wherein the machine-accessible medium further includes instructions that, when executed by the machine, cause the machine to perform the method of claim 2.
